(19) United States
(12) Patent Application Publication
(10) Pub. No.: US 2020/0028401 A1
(43) Pub. Date: Jan. 23, 2020

(54) ROTARY ELECTRIC MACHINE AND TURBINE SYSTEM

(71) Applicants: Kabushiki Kaisha Toshiba, Minato-ku (JP); Toshiba Energy Systems & Solutions Corporation, Kawasaki-shi (JP)

(72) Inventors: Tomoyuki Takahashi, Kawasaki-shi (JP); Ken Nagakura, Kawasaki-shi (JP); Hiroyuki Yoda, Kawasaki-shi (JP); Daisuke Murata, Kawasaki-shi (JP); Hiroshi Kawakami, Kawasaki-shi (JP); Junichi Mori, Kawasaki-shi (JP); Masahiro Seki, Kawasaki-shi (JP)

(73) Assignees: Kabushiki Kaisha Toshiba, Minato-ku (JP); Toshiba Energy Systems & Solutions Corporation, Kawasaki-shi (JP)

(21) Appl. No.: 16/459,871

(22) Filed: Jul. 2, 2019

(30) Foreign Application Priority Data
Jul. 17, 2018 (JP) 2018-134254

(51) Int. Cl. H02K 5/12; H02K 9/08; H02P 8/36; C25B 1/04; H02K 7/18

(52) U.S. Cl. CPC H02K 5/12; H02K 9/08; F05B 2220/61; C25B 1/04; H02K 7/1823; H02P 8/36

(57) ABSTRACT

A rotary electric machine and a turbine system including a housing, and a hydrogen generator arranged into or on the housing. The hydrogen generator electrolytically generates hydrogen from water. The hydrogen generator supplies the hydrogen into the housing.

### CROSS-REFERENCE TO RELATED APPLICATION

This application is based upon and claims the benefit of priority from the prior Japanese Patent Application No. 2018-134254, filed on Jul. 17, 2018, the entire contents of which are incorporated herein by reference.

### FIELD

Embodiments described herein relate generally to a rotary electric machine and a turbine system.

### BACKGROUND

Rotary electric machines, such as an electric generator, include a rotor within a stator. The stator includes a plurality of stator coils. Throughout generating output power, the generator creates heat such that a coolant through the stator coil is required to prevent overheating. The coolant including a hydrogen gas passes through flow paths in the stator coil. The hydrogen gas, for instance, flows from a high-pressure gas cylinder into the flow paths, which has a few million pascals.

### BRIEF DESCRIPTION OF THE DRAWINGS

FIG. 1 illustrates a schematic view of a turbine system according to a first embodiment.

FIG. 2 illustrates a schematic view of a rotary electric machine from the turbine system, according to the first embodiment.

FIG. 3 illustrates the main components of a hydrogen generator according to the first embodiment.

FIG. 4 illustrates a schematic view of a rotary electric machine from a turbine system according to a second embodiment.

### DETAILED DESCRIPTION

According an embodiment, a rotary electric machine includes a housing enclosing a rotor and a stator, and a hydrogen generator arranged into or on the housing, which is configured to electrolytically generate hydrogen from water, wherein the generated hydrogen is supplied to the rotor and the stator to be cooled.

Reference will now be made in detail to the present embodiment of the exemplary embodiments, examples of which are illustrated in the accompanying drawings. Whenever possible, the same reference numbers will be used throughout the drawings to refer to the same or like parts.

### First Embodiment

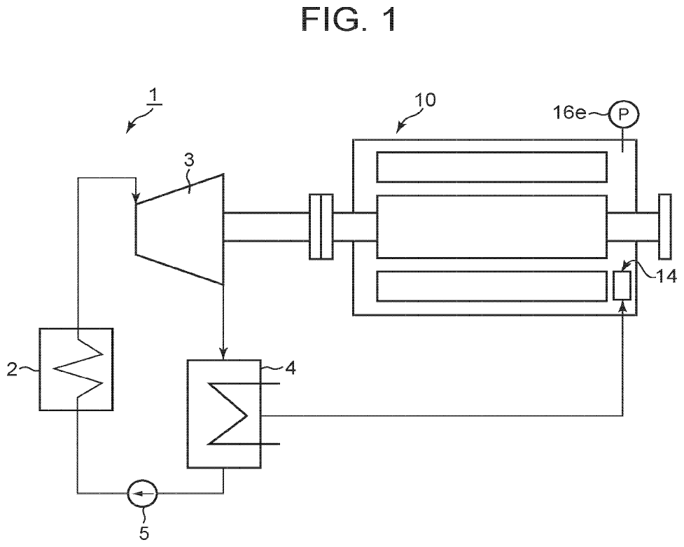

FIG. 1 illustrates a schematic view of a turbine system 1 according to a first embodiment. The turbine system 1 includes a boiler 2, a steam turbine 3, a condenser 4, a feed-water pump 5, and a rotary electric machine 10.

The boiler 2 has a heat exchanger to generate main steam, which is arranged in an upstream side of the steam turbine 3. The boiler 2 generates the main steam by vaporizing feed water.

The steam turbine 3 connects to the boiler 2 via a main steam line including a steam control valve. The steam turbine 3 includes a turbine casing, a turbine rotor placed in the turbine casing, a plurality of stages of rotor blades radially arranged on an outer surface of the turbine rotor, a plurality of stages of stator vanes radially arranged on an inner surface of the turbine casing, a nozzle box placed on the inlet side of the steam turbine, and an exhaust area defined in the outlet side of the turbine casing. Each stage of rotor blades is axially arranged on the outer surface of the turbine rotor. Each stage of stator vanes is arranged alternately to each stage of rotor blades.

The condenser 4 connects to the downstream side of the steam turbine 3, preferably the downstream side of the exhaust area. The condenser 4 includes a condenser shell and a plurality of tube bundles. The tube bundles are placed in the condenser shell, through which cooling water flows. The downstream side of the condenser shell connects to the boiler 2 via a pipe on which the feed-water pump 5 is arranged.

The rotary electric machine 10 is a turbine dynamo, which will be discussed in more detail below. The rotary electric machine 10 connects to the condenser 4, particularly the downstream side of the condenser shell, via a pipe.

The boiler 2 generates the main steam by vaporizing the feed water. The main steam, flowing through the main steam line, supplies into the steam control valve. The steam control valve regulates the flow rate of the main steam, thus providing the main steam into the nozzle box in the steam turbine 3. This steam in the nozzle box alternately flows each stage of rotor blades and each stage of the stator vanes, thus driving each stage of rotor blades and the turbine rotor so as to produce mechanical work. The mechanical work produced in the steam turbine 3 drives the rotary electric machine via the rotor. The steam after flowing through the last stage of rotor blades, called exhaust steam, passes sequentially through the exhaust area and the condenser 4. In the condenser 4, the tube bundles use the cooling water to cool the exhaust steam, thus transforming the exhaust steam into condensed water. The condensed water is supplied from the condenser 4 into the feed-water pump 5. Under a pressure, the feed-water pump 5 changes the condensed water into the feed water. This feed water is resupplied to the boiler 2. In this embodiment, a portion of the condensed water flows into the rotary electric machine 10.

In the above embodiment, the turbine rotor in the steam turbine 3 is coupled to a rotor (rotor 14) in the rotary electric machine 10. The coupling to the rotary electric machine 10 is not limited to this coupling. For example, a gas turbine rotor in a gas turbine may be coupled to the rotary electric machine 10.

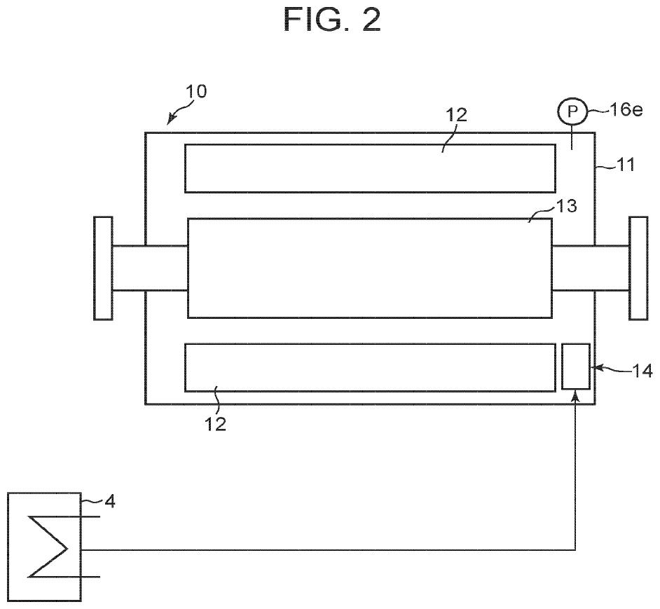

FIG. 2 illustrates a schematic view of a rotary electric machine 10 from the turbine system 1, according to the first embodiment. The rotary electric machine 10 is a rotary electric machine, including a housing 11, a stator 12, a rotor 13, and a hydrogen generator 14.

The housing 11 accommodates the stator 12, the rotor 13, and the hydrogen generator 14. The housing 11 is filled with hydrogen gas for coolant at a predetermined pressure.

The stator 12, shaped in a substantially cylindrical and hollow body, supports a plurality of stator coils (not shown) radially arranged. The stator 12 has a plurality of radial passages (not shown) through which the hydrogen gas flows.

The rotor 13, including a rotor coil (not shown), is rotatably placed in a housing 11. The rotor 13 is coaxially coupled to the turbine rotor. The rotor 13 is arranged with the stator 13 and at least partially surrounded by the stator 12. The rotor 13 also includes a plurality of radial passages (not shown) through which the hydrogen gas flows.

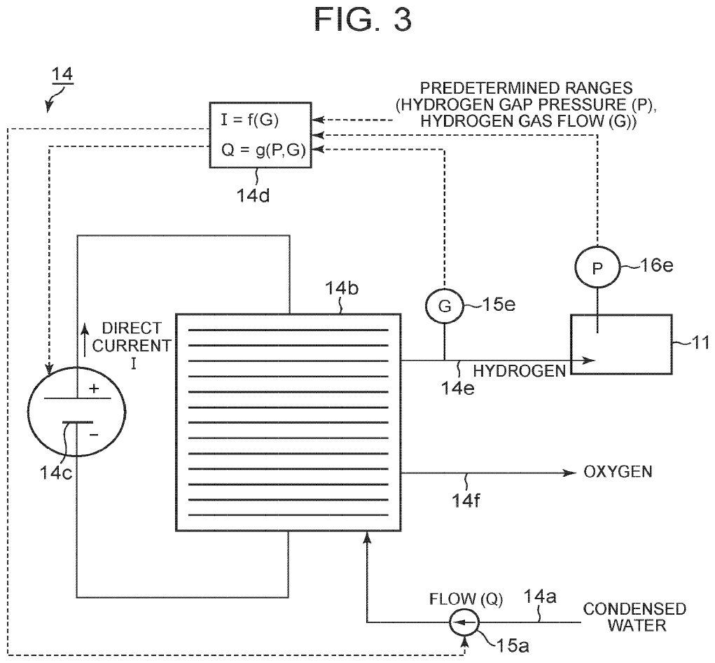

FIG. 3 illustrates the main components of the hydrogen generator 14 according to the first embodiment. The hydrogen generator 14 includes a water supply path 14a, an electrolysis stack 14b, a DC power supply 14c, a regulator 14d, a hydrogen exhaust path 14e, an oxygen exhaust path 14f, a flow detector 15e, and a pressure detector 16e. This hydrogen generator 14 may include sensors, disposed in the housing 11, to measure hydrogen pressure or hydrogen purity.

The water supply path 14a is a pipe connecting between the condenser 4 and the electrolysis stack 14b, which includes a water flow pump 15a. The water supply path 14a flows condensed water into the electrolysis stack 14b. This water supply path 14a is not limited to connect the condenser 4. In some embodiments, the water supply path 14a may connect a halfway stage of the steam turbine 3 and the electrolysis stack 14b, thus enabling partially to flow extraction steam supplied from the halfway stage into the electrolysis stack 14b. Alternatively, the water supply path 14a may connect a pure-water line included in a water cooled generator, thus enabling partially to flow pure-water through the pure-water line into the electrolysis stack 14b. Alternatively, the water supply path 14a may connect a water supply source placed externally and the electrolysis stack 14b, thus enabling to flow deionized water provided from the water supply source into the electrolysis stack 14b. The water supply source should regulate the conductivity of this water within a predetermined range.

The electrolysis stack 14b includes an electrochemical cell, which electrolyzes condensed water to hydrogen gas and oxygen gas. This hydrogen gas is used as a coolant. The electrolysis stack 14b electrolytically generates hydrogen gas and oxygen gas by applying a DC current to the condensed water. Although the cell is preferably a polymer electrode membrane (PEM) type, the cell may be any other suitable electrochemical cell: alkaline type, phosphoric acid type, or solid oxide type. The cell can also have any suitable structure: a planner type, a cylindrical type, or a cylindrical planner type.

The DC power supply 14c is a current source including a converter, electrically connecting to the electrolysis stack 14b. The DC power supply 14c applies a DC current into the electrolysis stack 14b.

The regulator 14d electrically connects with the water flow pump 15a, the DC power supply 14c, and the pressure detector 16e. The regulator 14d regulates the current supplied into the electrolysis stack 14b and a water flow through the path 14a in accordance with predetermined relationships. In this embodiment, one relationship is defined between the flow detected by the flow detector 15e and the current from the DC power supply 14c, and another relationship is defined among the flow, the pressure detected by the pressure detector 16e, and the water flow. However, another relationship is not limited to define the water flow. In some embodiments, the water flow may be the water pressure.

The hydrogen exhaust path 14e is a pipe, which exhausts hydrogen gas from the electrolysis stack 14b into the housing 11.

The oxygen exhaust path 14f is a pipe, which exhausts oxygen gas from the electrolysis stack 14b to an external.

The flow detector 15e is placed on the hydrogen exhaust path 14e, detecting the hydrogen gas flow through the hydrogen exhaust path 14e.

The pressure detector 16e is placed on the housing 11, which detects the hydrogen gas pressure in the housing 11.

In some embodiments, the rotary electric machine 10 may include an oxygen pressure detector placed on the oxygen exhaust path 14f, to monitor the oxygen gas pressure in the oxygen exhaust path 14f. Alternatively, the rotary electric machine 10 may include sensors detecting the purity of hydrogen gas in the housing 11 and the output.

The following describes a cooling process of this embodiment. Rotating the rotor 13 by passing a field current through the rotor coil induces an inductive current through the stator coil supported by the stator 12. This yields the generation of heat in the rotor coil and the stator coil. To prevent overheating, the stator 12 and the rotor 13 need to be cool.

In the hydrogen generator 14, the flow detector 15e detects a hydrogen gas flow (G) and the pressure detector 16e detects a hydrogen gas pressure (P). The regulator 14d receives the hydrogen gas flow (G) and the hydrogen gas pressure (P). The regulator 14d regulates the DC current (I) and the water flow (Q), using the gas flow (G) and the gas pressure (P). This allows the hydrogen generator 14 to regulate the hydrogen gas flow (G) and the hydrogen gas pressure (P) within predetermined ranges. The electrolysis stack 14b electrolytically generates hydrogen and oxygen by applying the DC current to the condensed water at the DC current (I) and the water flow (Q). The electrolysis stack 14b supplies the hydrogen gas into the housing 11 via the hydrogen exhaust path 14e, and exhausts the oxygen gas to an external via the oxygen exhaust path 14f.

In the housing 11, the hydrogen gas passes through the radial passages in the stator 12 and the rotor 13, thus cooling the stator 12 and the rotor 13. This hydrogen gas after cooling is exhausted into the housing 11, re-cooled by releasing heat to an external via the surface of the housing 11. In some embodiments, the rotary electric machine 10 may include a gas cooler to re-cool the hydrogen gas after cooling the stator 12 and the rotor 13.

When the hydrogen gas pressure (P) falls within the predetermined range, the regulator 14d controls the DC power supply 14c to stop applying the DC current into the electrolysis stack 14b. This allows to keep the hydrogen gas pressure in the housing 11 within a predetermined range.

The first embodiment advantageously proposes a rotary electric machine 10 including the hydrogen generator 14. The hydrogen generator 14, which generates hydrogen gas by electrolyzing water, supplies hydrogen gas into a stator 12 and a rotor 13 safely, thus allowing to be placed into the housing 11. This structure needs no external pipe to supply hydrogen gas into the stator 12 and the rotor 13.

In the first embodiment, the rotary electric machine 10 may include one or more hydrogen generator 14. The hydrogen generator 14 may further include a relief valve, a pressure-regulating valve, or a check valve disposed on an outlet side of the hydrogen exhaust path 14e.

### Second Embodiment

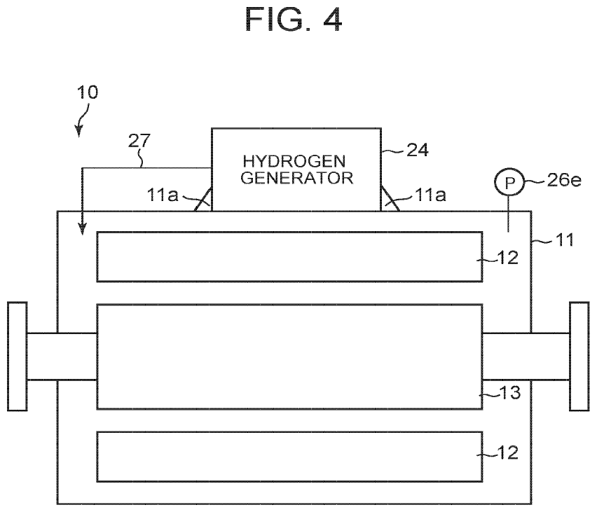

FIG. 4 illustrates a schematic view of a rotary electric machine from a turbine system according to a second embodiment. The following describes the second embodiment. More specifically, the following describes only the difference between the first embodiment and the second embodiment. The same points between the embodiments skip the descriptions. Alternately, the turbine system in the first embodiment may include the rotary electric machine in the second embodiment.

In the second embodiment, the rotary electric machine 10 includes the housing 11, the stator 12, the rotor 13, a hydrogen generator 24, and a hydrogen supply line 27 (a first hydrogen supply line). This rotary electric machine 10 has the difference to include the hydrogen generator 24 and the hydrogen supply line 27, instead of the hydrogen generator 14 of the first embodiment.

The housing 11 includes a seat 11a to removably mount the hydrogen generator 24. The seat 11a is placed on the outer surface of the housing 11.

The hydrogen generator 24 includes a water supply path 24a, an electrolysis stack 24b, a DC power supply 24c, a regulator 24d, a hydrogen exhaust path 24e, an oxygen exhaust path 24f, a flow detector 25e, and a pressure detector 26e. These components are the same in the hydrogen generator 14 of the first embodiment. The hydrogen generator 24 is placed on the outer surface of the housing 11 with the seat 11a. In some embodiment, the rotary electric machine 10 may include a plurality of hydrogen generators 24. Each of these hydrogen generators 24 is mounted onto each of the seats 11a that are placed on the outer surface of the housing 11.

The hydrogen supply line 27 connects between an inside of the housing 11 and the hydrogen exhaust path 24e. In the second embodiment, the hydrogen supply line 27 gastightly penetrate the surface of the housing 11, thus enabling the housing 11 to leak no hydrogen gas.

The electrolysis stack 24b supplies the hydrogen gas into the housing 11 via the hydrogen supply line 27.

The second embodiment advantageously proposes a rotary electric machine 10 including the hydrogen generator 24. The hydrogen generator 24 is placed on the outer surface of the housing 11 via the seat 11a. This structure allows the hydrogen supply line 27 to be shorter than the external pipe of the conventional structure. This structure may also transport the hydrogen generator 24 to a construction site with the housing 11. This structure may separately transport the housing 11 and the hydrogen generator 24 to the construction site, then combining the hydrogen generator 24 to the housing 11 in the site.

In the second embodiment, the hydrogen supply line 27 may include a flow control valve, a relief valve, or a check valve.

While certain embodiments have been described, these embodiments have been presented by way of example only, and are not intended to limit the scope of the inventions. Indeed, the novel embodiments described herein can be embodied in a variety of other forms; furthermore, various omissions, substitutions and changes in the form of the embodiments described herein can be made without departing from the spirit of the inventions. The accompanying claims and their equivalents are intended to cover such forms or modifications as would fall within the scope and spirit of the inventions.

1: A rotary electric machine comprising:
a housing enclosing a rotor and a stator; and
a hydrogen generator arranged into or on the housing, which is configured to electrolytically generate hydrogen from water;
wherein the generated hydrogen is supplied to the rotor and the stator to be cooled.

2: The rotary electric machine according to claim 1, the hydrogen generator further comprising:
a pressure detector configured to detect internal pressure in the housing;
a flow detector configured to detect water flow to the hydrogen generator; and
a regulator configured to regulate at least one of gas flow or pressure of the generated hydrogen in accordance with the internal pressure.

3: A turbine system comprising:
a turbine comprising a turbine rotor; and
the rotary electric machine as in claim 1, wherein the rotor is rotatably coupled to the turbine rotor.

4: A turbine system comprising:
a turbine comprising a turbine rotor; and
the rotary electric machine as in claim 2, wherein the rotor is rotatably coupled to the turbine rotor.
